(19) United States
(12) Patent Application Publication
(10) Pub. No.: US 2015/0188154 A1
(43) Pub. Date: Jul. 2, 2015

(54) GASKET FOR FUEL CELLS

(71) Applicants: Hyundai Motor Company, Seoul (KR); Industry-Academic Cooperation Foundation, CHONBUK National University, Jeonju (KR)

(72) Inventors: Byeong Heon Jeong, Seongnam (KR); Bo Ki Hong, Seoul (KR); Chang Woon Nah, Jeonju (KR); Yong Hwan Yoo, Jeonju (KR)

(21) Appl. No.: 14/453,916

(22) Filed: Aug. 7, 2014

(30) Foreign Application Priority Data
Dec. 27, 2013 (KR) 10-2013-0164905

(51) Int. Cl. H01M 8/02

(52) U.S. Cl. CPC H01M 8/0284; H01M 2250/20; H01M 2008/1095

(57) ABSTRACT

A gasket for fuel cells is provided. In particular the gasket may include 1˜5 phr (parts per hundred rubber) of a peroxide crosslinking agent; 0.1˜1 phr of a co-crosslinking agent; 0.1˜1 phr of an antioxidant; and 1˜10 phr of carbon black, in comparison with 100 phr of ethylene-propylene diene monomer (EPDM) rubber, respectively. In particular, the EPDM rubber may include 50˜60 wt. % of ethylene and 4˜10 wt. % of a diene monomer.

### CROSS-REFERENCE(S) TO RELATED APPLICATION

The present application claims priority of Korean Patent Application Number 10-2013-0164905 filed on Dec. 27, 2013, the entire contents of which is incorporated herein for all purposes by this reference.

### BACKGROUND OF THE INVENTION

1. Technical Field

The present invention relates to a gasket for fuel cell stacks, which has excellent cold resistance and high compressive strain resistance. More particularly, the present invention relates to a gasket for fuel cells, which has a low compression set and does not contain impurities such as metal ions.

2. Description of the Related Art

A fuel cell stack is typically made by repeatedly assembling several hundred unit cells. Each of these unit cells are provided with a rubber gasket to seal within the cell reaction gases and cooling water. Further, since several hundred unit cells are stacked under a predetermined compressive load, each rubber gasket is left for eighty thousands hours under a compressed state over the course of for example a 10-year warranty. Additionally, a fuel cell stack is generally operated under various conditions of temperature, pressure and relative humidity. Most of all, it is important that the fuel cell stack be airtight during use.

For this purpose, a rubber gasket for fuel cell stacks must maintain highly elastic and must have very high resistance to compressive deformation. As a rubber gasket for fuel cell stacks, fluoroelastomers, silicone elastomers and hydrocarbon elastomers are generally used Their respective advantages and disadvantages are described as follows.

Conventionally, as a gasket for fuel cells, fluoroelastomers having excellent physical properties such as heat resistance, acid resistance, elasticity and the like and having the highest reliability have been used. However, fluoroelastomers are problematic in terms of mass production of gaskets because they have low injection moldability and cold resistance and are expensive. Furthermore even though when fluoroelastomers are cross-linked with peroxides, they can be used even at a low temperature of −30° C. or less, there is a heavy economic burden on automotive companies when several hundreds of gaskets could potentially have to be replaced with these ultrahigh-priced fluoroelastomers.

Silicone elastomers are classified into general silicone rubbers such as polydimethylsiloxane and the like and modified silicon rubbers such as fluorosilicone and the like. Solid silicone rubbers may be used, but liquid silicone rubbers are advantageous for precise injection molding and thus are more frequently used. However, although liquid silicone rubbers advantageously exhibit excellent injection moldability, silicone may be eluted as an impurity and thus a platinum catalyst may become poisoned, thus reducing fuel cell performance. Accordingly, they are not suitable for fuel cells.

As hydrocarbon elastomers, ethylene-propylene diene monomer (EPDM) rubber, ethylene-propylene rubber (EPR), isoprene rubber (IR), isobutylene-isoprene rubber (BR) and the like are frequently used. These hydrocarbon elastomers exhibit excellent airtightness even at a low temperature of −40° C. or less and are must cheaper than the materials described above. However, they cannot be easily used at a high temperature of 120° C. or higher because of their insufficient heat resistance. Additionally, the physical properties such as elasticity, oxidation resistance and the like are greatly deteriorated at high temperatures.

For example, an EPDM rubber sample was added to a solution (1M H₂SO₄+10 ppm HF) for simulating severe fuel cell operation conditions, and was then stored at 80° C. for 6 weeks. Then, the surface shape and components of the sample were analyzed by a scanning electron microscope (SEM). As a result, a zinc (Zn) component, which is a metal component, remains on the surface of the sample. When such an additive or process oil containing a metal ion component is used in a gasket for fuel cell stacks, the gasket deteriorates depending on the increase in mileage of a fuel cell car. As a result the elasticity of the gasket may be reduced. Additionally, metal ions (impurities) eluted from the gasket can contaminate a membrane-electrode assembly (MEA), which is one of the components of a fuel cell stack, thus deteriorating the performance of a fuel cell. Moreover, this also reduces the life span of a fuel cell stack, and thus currently conventional EPDM rubber cannot be applied to a gasket for fuel cell stacks.

It is to be understood that the foregoing description is provided to merely aid the understanding of the present invention, and does not mean that the present invention falls under the purview of the related art which was already known to those skilled in the art.

### SUMMARY OF THE INVENTION

Accordingly, the present invention has been devised to solve the above-mentioned problems, and an object of the present invention is to provide a gasket for fuel cells, which has a low compression set and does not contain impurities including metal ions.

In order to accomplish the above object, an aspect of the present invention provides a gasket for fuel cells, including: 1˜5 phr (parts per hundred rubber) of a peroxide crosslinking agent; 0.1˜1 phr of a co-crosslinking agent; 0.1˜1 phr of an antioxidant; and 1˜10 phr of carbon black, in comparison with 100 phr of EPDM rubber, respectively, wherein the EPDM rubber includes 50˜60 wt. % of ethylene and 4˜10 wt. % of a diene monomer.

The peroxide crosslinking agent may include at least one selected from among dicumyl peroxide, 2,5-dimethyl-2,5-di(t-butylperoxy)hexane, di-(2-t-butylperoxyisopropyl)benzene, di-(2,4-dichlorobenzoyl) peroxide, di(4-methylbenzoyl) peroxide, t-butyl peroxybenzoate, dibenzoyl peroxide, 1,1-di-(t-butylperoxy)-3,3,5-trimethykyclohexane, t-butyl cumyl peroxide, and di-t-butyl peroxide.

The gasket for fuel cells may also have a Shore A hardness value of 40˜70, based on ASTM D2240, and a compression set of 10% or less may be applied, based on ASTM D395 (Method B, 25% Deflection, 72 hours @100° C.).

Additionally, the gasket for fuel cells abuts a membrane-electrode assembly (MEA), a gas diffusion layer (GDL), a separator, a hydrogen supply unit, an air supply unit or a heat control unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a graph showing the results of evaluating the influence of an antioxidant on the compression set of a gasket for fuel cells according to an exemplary embodiment of the present invention; and

FIG. 2 is a graph showing the low-temperature retraction characteristics of a gasket for fuel cells according to an exemplary embodiment of the present invention.

### DESCRIPTION OF THE PREFERRED EMBODIMENTS

Hereinafter, preferred embodiments of the present invention will be described in detail with reference to the attached drawings.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention provides a rubber gasket for fuel cell stacks, which has excellent cold resistance and high compressive strain. More particularly, the present invention provides a gasket for fuel cells, which has a low compression set and does not contain impurities including metal ions, the gasket including: about 1˜5 phr (parts per hundred rubber) of a peroxide crosslinking agent; about 0.1˜1 phr of a co-crosslinking agent; about 0.1˜1 phr of an antioxidant; and about 1˜10 phr of carbon black, in comparison with about 100 phr of EPDM rubber, respectively, wherein the EPDM rubber includes about 50˜60 wt. % of ethylene and about 4˜10 wt. % of a diene monomer.

In order to solve the above-mentioned conventional problems, the present invention provides a highly elastic EPDM rubber gasket which can be effectively used in fuel cells. In particular, the above rubber gasket maintains high cold resistance, the resistance of the gasket to compressive deformation is improved due to the high crosslink density thereof, and additives including metal ions are not present. As a result the factors that reduce the electrochemical performance of a fuel cell stack have been removed.

Further, the present invention intends to provide a rubber compound obtained by crosslinking an EPDM rubber with a peroxide crosslinking agent. In particular, the EPDM rubber satisfies all the physical properties, such as excellent cold resistance, high heat resistance, low compression set and the like, required for hydrogen-powered fuel cell vehicles, and is advantageous for mass production due to its high price competitiveness.

For example, as evidence of the gaskets abilities, components and physical properties of the EPDM rubber compound of Example 1 according to the present invention have been compared with those of conventional EPDM rubber compounds of Comparative Examples 1 to 6, and the results thereof are given Tables 1 and 2 below. The rubber compound for fuel cells according to an embodiment of the present invention includes EPDM rubber cross-linkable with peroxides, and may further include a reinforcing filler, such as carbon blacks, layered clays or the like, a co-crosslinking agent, primary and secondary antioxidants, and the like. In contrast, the conventional EPDM rubber compound including a sulfur crosslinking agent cannot have a proper compression set.

More specifically, the EPDM rubber used in the present invention is a ternary copolymer including ethylene, propylene and a diene monomer having a double bond. Additionally, the content of ethylene is 50 wt. % or more, preferably, 55 to 60 wt. %, and the content of a diene monomer is 5 to 10 wt. %. This EPDM rubber is referred to as “a liquid or solid copolymer cross-linkable with peroxides,” and contributes to the improvement of cold resistance and price competitiveness. In the exemplary embodiment of the present invention, EPDM rubber including 7.9 wt. % of a diene monomer and having a Mooney viscosity of 56 under a condition of ML(1+4) at 125° C. is used.

The peroxide crosslinking agent used in the present invention functions to crosslink the EPDM rubber, and may include one or more selected from among dicumyl peroxide having a purity of 90% or more, 2,5-dimethyl-2,5-di(t-butylperoxy)hexane, di-(2-t-butylperoxyisopropyl)benzene, di-(2,4-dichlorobenzoyl) peroxide, di(4-methylbenzoyl) peroxide, t-butyl peroxybenzoate, dibenzoyl peroxide, 1,1-di-(t-butylperoxy)-3,3,5-trimethylcyclohexane, t-butyl cumyl peroxide, and di-t-butyl peroxide. In the EPDM rubber according to an embodiment of the present invention, a peroxide crosslinking agent, rather than a sulfur crosslinking agent, is used.

As a result, the co-crosslinking agent used in the present invention serves to increase crosslinking efficiency by accelerating crosslinkage and to decrease a compression set. As the co-crosslinking agent, acrylate having a purity of 90% or more, methacrylate, vinyl ether, triallyl cyanurate (TAC), triallyl isocyanurate (TAIC) or the like may be used. In the EPDM rubber of Comparative Examples including a sulfur crosslinking agent, tetramethyl thiuram disulfide (TMTD) or bibenzothiazolyl disulfide (MBTS) is generally used as the co-crosslinking agent.

In the EPDM rubber of Comparative Examples, the co-crosslinking agent (a crosslink accelerator) is generally used in combination with zinc oxide (ZnO) and stearic acid. However, in this case, impurities, such as metal ions and the like, are eluted, and, when a peroxide crosslinking agent is used, the crosslinkage of the compound is disturbed by the impurities, thus lowering a crosslinking rate and crosslink density. Therefore, it is preferred that a metal component not be mixed with the rubber compound for fuel cells.

The carbon black used in the present invention serves to enhance the hardness and mechanical properties of the EPDM rubber, and may be, for example, carbon black having a grade of HAF (High Abrasion Furnace), FEF (Fast Extrusion Furnace), SAF (Super Abrasion Furnace), ISAF (Intermediate Super Abrasion Furnace), or GPF (General Purpose Furnace). The carbon black may have a particle diameter of 10 to 500 nm. Layered clays may alternatively be independently used instead of carbon black, or may be used in combination with carbon black. However, when the clay is used, a polyolefin-based polymer or hydrocarbon-based elastomer surface-modified with maleic anhydride, which can increase the interlayer distance of the clay, may be or is preferably mixed with the clay.

The antioxidant used in the present invention is added in order to prevent the EPDM rubber for fuel cells from being oxidized and deteriorated by oxygen in the air to inhibit the quality degradation thereof. Such an effect can be obtained by the inhibition of a chain initiation step or chain propagation step in a radical reaction (deteriorative reaction due to oxidation) or the decomposition of peroxide. In this case, a radical scavenger and a peroxide decomposer may be used independently or in a mixture thereof. In the EPDM rubber according to an exemplary embodiment of the present invention, there is used a phenol-based antioxidant, which functions to scavenge radicals to prevent the oxidization and deterioration of the EPDM rubber. Meanwhile, when the antioxidant is excessively used, the antioxidant attacks the crosslinked site of the EPDM, thus deterioration of physical properties thereof. Therefore, it is necessary to select the optimal amount of an antioxidant.

The compound formulations and physical properties of the gaskets for fuel cells of Comparative Examples 1 to 6 and Example 1 are given in Tables 1 and 2 below.

TABLE 1
Compound formulations of gasket for fuel cells

(Units: phr)

| | Comp. Ex. | | | | | | Ex. |
|---|---|---|---|---|---|---|---|
| Components | 1 | 2 | 3 | 4 | 5 | 6 | 1 |
| EDPM-A (Mooney | 100 | 100 | 100 | 100 | 0 | 0 | 100 |
| viscosity: 56, | | | | | | | |
| Diene: 7.9 wt. %) | | | | | | | |
| EDPM-B (Mooney | 0 | 0 | 0 | 0 | 100 | 0 | 0 |
| viscosity: 28, | | | | | | | |
| Diene: 7.9 wt. %) | | | | | | | |
| EDPM-C (Mooney | 0 | 0 | 0 | 0 | 0 | 100 | 0 |
| viscosity: 42, | | | | | | | |
| Diene: 4.5 wt. %) | | | | | | | |
| Sulfur | 0.2 | 0.5 | 1.5 | 0 | 0 | 0 | 0 |
| Organic peroxide | 0 | 0 | 0 | 3 | 3 | 3 | 3 |
| Tetramethyl thiuram | 1 | 1 | 1 | 0 | 0 | 0 | 0 |
| difulfide | | | | | | | |
| Benzothiazoyl | 0.5 | 0.5 | 0.5 | 0 | 0 | 0 | 0 |
| disulfide | | | | | | | |
| Co-crosslinking | 0 | 0 | 0 | 1 | 1 | 1 | 1 |
| agent | | | | | | | |
| ZnO | 5 | 5 | 5 | 5 | 5 | 5 | 0 |
| Stearic acid | 1 | 1 | 1 | 1 | 1 | 1 | 0 |
| Carbon black | 5 | 5 | 5 | 5 | 5 | 5 | 5 |
| Antioxidant | 0 | 0 | 0 | 0 | 0 | 0 | 0.1 |

Hereinafter, the EPDM rubber compounds used in the gasket for fuel cells according to the present invention are described in detail with reference to the following Comparative Examples 1 to 6 and Example 1.

### Comparative Examples 1 to 3

Each of the EPDM rubber compounds of Comparative Examples 1 to 3 includes 100 phr of EPDM rubber crosslinked with sulfur including 57 wt. % of ethylene and 7.9 wt. % of a diene monomer; 0.2˜1.5 phr of a sulfur crosslinking agent; 1.5 phr of a co-crosslinking agent; and 5 phr of carbon black Here, zinc oxide (ZnO) and stearic acid, as crosslinking accelerators, were used in amounts of 5 and 1 phr, respectively, but a phenol-based antioxidant functioning to scavenge radicals was not used. The primary mixing procedure of these components was carried out at a rotor speed of 40 to 50 RPM using a Banbury mixer (Namyang Co., Ltd, Korea). First, EPDM was masticated for 2 minutes, and was then mixed with carbon black at a temperature of 140° C. or lower to obtain a first mixture. Subsequently, the secondary mixing procedure was carried out using a two-roll mixer (DS-1500R, Withlab Co., Ltd, Korea). That is, a sulfur crosslinking agent and a co-crosslinking agent (a crosslink accelerator) were finally mixed with the first mixture for 20 minutes to prepare an EPDM rubber compound. The prepared EPDM rubber compound was aged at room temperature for about 24 hours, and then the crosslinking characteristics thereof were evaluated using ODR (Oscillating Disk Rheometer, Alpha Technologies). Specifically, a specimen for measuring mechanical properties and to compression set behaviors were fixed in a mold having a size of 150 mm×150 mm×2 mm and a standard mold based on ASTM D295, respectively, by a hydraulic press, and were then crosslinked at 170° C. for optimum crosslinking time (t′ 90, min) to prepare a final rubber specimen, and then all the physical properties of the prepared rubber specimen were evaluated. Since the compression set of the rubber specimen is very high, this rubber specimen is not suitable as a gasket material for fuel cells. Detailed description thereof will be omitted.

### Comparative Examples 4 to 6

Each of the EPDM rubber compounds of Comparative Examples 4 to 6 was obtained by crosslinking 100 phr of EPDM-A, EPDM-B or EPDM-C rubber including 57 wt. % of ethylene and 4.5 or 7.9 wt. % of a diene monomer with 3 phr of a peroxide crosslinking agent. Here, zinc oxide (ZnO) and stearic acid, as crosslink accelerators, were used in amounts of 5 and 1 phr, respectively, and carbon black and a co-crosslinking agent were used in amounts of 5 and 1 phr, respectively. Further, a phenol-based antioxidant functioning to scavenge radicals was not used. The EPDM rubber compounds of Comparative Examples 4 to 6 were prepared under the same conditions as for Comparative Examples 1 to 3.

### Example 1

The EPDM rubber compounds of Example 1 was obtained by crosslinking 100 wt. % of EPDM rubber including 57 wt. % of ethylene and 7.9 wt. % of a diene monomer with 3 phr of a peroxide crosslinking agent. Here, zinc oxide (ZnO) and stearic acid, as crosslinking accelerators, were not used because they prevent the compound from being cross-linked with the peroxide crosslinking agent and elute metal ions from the compound. The amounts of carbon black and a co-crosslinking agent were the same as those in Comparative Examples 4 to 6. The EPDM rubber compound Example 1 was prepared under the same conditions as in Comparative Examples 1 to 3.

The results of evaluating the physical properties of the EPDM rubber compounds of Comparative Examples 1 to 6 and Example 1 are as follows.

TABLE 2
Physical properties of EPDM rubber compounds

| | Comp. Ex. | | | | | | Ex. |
|---|---|---|---|---|---|---|---|
| Items | 1 | 2 | 3 | 4 | 5 | 6 | 1 |
| Hardness (Durometer A) | 45 | 47 | 51 | 55 | 55 | 56 | 55 |
| Maximum tensile | 3.8 | 3.4 | 4.8 | 3.7 | 3.5 | 3.2 | 2.5 |
| strength (MPa) | | | | | | | |
| Elongation at break (%) | 611 | 410 | 312 | 181 | 196 | 213 | 161 |
| tₛ2 (min) | 3.7 | 3.3 | 2.9 | 1.8 | 2.3 | 1.7 | 2.4 |
| t′ 90 (min) | 12.6 | 9.0 | 7.3 | 23.6 | 23.9 | 20.2 | 24.1 |
| Crosslink density | 6.6 × 10⁻⁵ | 1.2 × 10⁻⁴ | 1.9 × 10⁻⁴ | 2.8 × 10⁻⁴ | 3.0 × 10⁻⁴ | 2.6 × 10⁻⁴ | 3.1 × 10⁻⁴ |
| (mol/cm³) | | | | | | | |
| Compression set (%, 72 | 44.1 | 58.6 | 64.1 | 5.3 | 5.4 | 6.6 | 2.7 |
| h, 100° C.) | | | | | | | |
| Low temperature | — | — | — | −48 | −49 | −42 | −48 |
| retraction (TR-10, ° C.) | | | | | | | |

The physical properties of the EPDM rubber compounds of Comparative Examples 1 to 6 and Example 1 were measured as follows.

1) Hardness: Shore A hardness was measured based on ASTM D2240.

2) Tensile property: maximum tensile strength and elongation at break were measured based on ASTM D412.

3) Curing Property: a cure curve was measured using an oscillation disk rheometer (ODR) under the conditions of temperature 170° C., oscillation frequency 1.67 Hz and time 60 min, based on ASTM D2084.

4) Crosslink density: a standard specimen was immersed in an n-dodecane solution and swelled at 25° C. for 15 hours, and then the crosslink density thereof was measured based on ASTM D471.

5) Compression set: a standard specimen was heat-treated at 100° C. for 72 hours, and then the compression set thereof was measured based on ASTM D395 (Method B, 25% Deflection).

6) Low temperature retraction: TR-10 was measured based on ASTM D1329

[Hardness]

In the case of a gasket for a fuel cell stack, in order to maintain the intimate contact and airtightness between several hundred parts that make up a fuel cell stack, it is important that hardness is uniformly adjusted. When an EPDM rubber having a relatively high Shore A hardness value of 65 or more is used, it is difficult to secure airtightness. Further, when an EPDM rubber having a Shore A hardness of 35 or less is used, crosslink density is reduced, so the elasticity of a gasket is greatly decreased. The compression set thereof is inversely proportional to elasticity increased at an optimum level or more, and the excessive compression of unit cells is caused due to low hardness. Therefore, it is preferred that an EPDM rubber having a Shore hardness value of 35 to 65 be used. In the present invention, in Comparative Examples 1 to 6 and Example 1, an EPDM rubber compound having a Shore hardness value of about 55 was prepared, and then other physical properties and performance thereof were measured and compared.

[Mechanical Property]

Since a tensile test is the most basic test used for measuring this characteristic, the evaluation results thereof are given in Table 2 above. Consequently, it can be ascertained that the maximum tensile strength and elongation at break of the EPDM rubber compound of Example 1 are slight lower than those of the EPDM rubber compounds of Comparative Examples 1 to 6. However, since the tension mode is not applied to a gasket for a fuel cell stack, these results are used as reference data because they are not directly related to the performance of a fuel cell stack. Meanwhile, since the mechanical properties of the EPDM rubber compound can be improved at a predetermined level or more using a filler such as carbon black, they were not optimized for use in the fuel cell stack.

[Curing Property]

In the case of a gasket for a fuel cell stack, in order to integrate a membrane-electrode assembly, a gas diffusion layer or a separator with a gasket, an EPDM rubber compound is formed into a thin-film gasket by injection molding and primary crosslinking, and then the thin-film gasket passes through a secondary crosslinking process. Therefore, it is important to maintain a suitable crosslinking rate when the thin-film gasket is injection-molded in a mold. The crosslinking rate at the time of actual injection molding of a gasket compound can be simulated using an ODR method. In the ODR method, the scorch time (tₛ2) refers to a phenomenon where the fluidity of the gasket compound is deteriorated by a crosslinking reaction before the completion of molding. It is preferred that the scorch time (tₛ2) be 1.5˜2.5 minutes. When the scorch time is less than 15 minutes, there is a problem in that the injection-moldability of the gasket compound is deteriorated due to the excessive precuring thereof. Further, when the scorch time is more than 2.5 minutes, there is a problem in that the production cycle time of a gasket increases. As shown in Table 2 above, the scorch time of the EPDM rubber compound of Example 1 is 2.4 minutes, which is delayed by 0 6 minutes compared to that of the EPDM rubber compound of Comparative Example 4. Further, 90% cure time (t′ 90) is necessary for setting post curing conditions. From this 90% cure time (t′ 90), it can be seen that the EPDM rubber compounds of Comparative Examples 1 to 6 and Example 1 can have sufficient elasticity when they are maintained for 25 minutes or more at the same temperatures as the injection molding process.

[Crosslink Density]

Crosslink density is referred to as a ratio at which a polymer has three-dimensional network structures. Generally, as crosslink density increases, elasticity increases. As shown in Table 2 above, it can be ascertained that the crosslink density of the EPDM rubber compound of Example 1 is higher than that of the EPDM rubber compounds of Comparative Examples 1 to 6. That is, since the crosslink density of the EPDM rubber compound of Example 1 is higher than that of the EPDM rubber compounds of Comparative Examples 1 to 6, the compression set of the EPDM rubber compound of Example is lower than that of the EPDM rubber compounds of Comparative Examples 1 to 6, and thus the elasticity of the EPDM rubber compound of Example is higher than that of the EPDM rubber compounds of Comparative Examples 1 to 6.

[Compression Set]

In the case of a gasket for a fuel cell stack, a great compressive load is applied to the gasket when several hundred unit cells are compressed at certain compressive load.

Therefore, the elasticity of a gasket, (i.e., the repellency of a gasket to compression), is one of the most important evaluation item. As a test for simulating the elasticity of a gasket, a compression set test is generally examined. If the lifetime of a car is, for example, 10 years, a gasket for a fuel cell stack must maintain sufficient elasticity for 87,000 hours or more in a compressed state. As a result, it is preferred that the gasket have a low compression set.

For example, it is preferred that the gasket have a compression set of 5% or less when it is tested at 100° C. for 72 hours. As shown in Table 2 above, it can be ascertained that, in the compression sets measured after being maintained at 100° C. for 72 hours, the compression set of the EPDM rubber compound of Example 1 was decreased by 50% or more compared to those of the EPDM rubber compounds of Comparative Examples 4 to 6. This fact means that the elasticity of the EPDM rubber compound of Example 1 is higher than that of the EPDM rubber compounds of Comparative Examples 4 to 6. For this reason, when the EPDM rubber compound of Example 1 is applied to a gasket for a fuel cell stack, the airtightness and durability of the fuel cell stack can be improved, thus improving the long-term durability of a hydrogen-powered fuel cell car.

[Antioxidative Property]

A conventional polymer electrolyte membrane fuel cell stack is generally operated at a relatively low temperature range of 55 to 75° C., but is required to operate at a relatively high temperature range of 75 to 95° C. in order to improve the fuel efficiency thereof. Further, with the increase in the operation temperatures of the fuel cell stack, a gasket used in peripheral parts of the fuel cell stack is also required to have higher heat resistance. When a rubber elastomer is exposed to air and oxygen at high temperature, its physical properties are apt to be deteriorated by oxidation, so an antioxidant must be added to the rubber compound in order to improve the antioxidative property of the rubber compound at high temperatures.

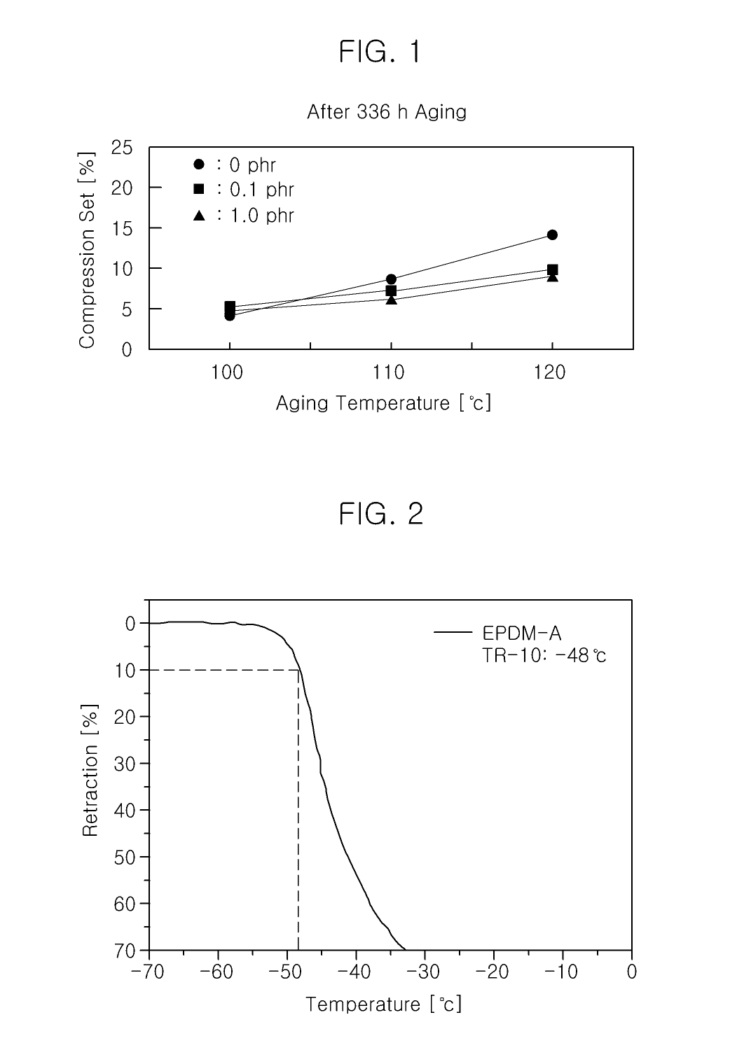

As shown in FIG. 1, it can be ascertained that the effect of an antioxidant increases depending on the increase of temperature. When the gasket was aged at 120° C. for 336 hours, its compression set was lowered by maximum 37%. Consequently, it is inferred that the high-temperature durability of the gasket was increased by the improvement of the high-temperature antioxidative property thereof.

[Low Temperature Retraction]

Generally, rubber exhibits elasticity at room temperature or higher, but when there is a drop in temperature, its elasticity is gradually lowered, and, finally, is completely lost at a predetermined temperature or lower. In the case of a gasket for a fuel cell stack, the vehicle may be operating in environments with low temperatures in cold climates. Additionally, operation at high temperatures should also be considered.

FIG. 2 shows the results of evaluating the low-temperature retraction (TR-10) of the EPDM rubber compound of Example 1. It is shown in FIG. 2 that the value of TR-10 is −48° C. From FIG. 2, it can be ascertained that, when the EPDM rubber compound of the present invention is applied to a gasket for a fuel cell stack, the reaction gases and cooling medium charged in the fuel cell stack can be sufficiently sealed even in an ultra-low temperature environment.

According to the above-configured gasket for fuel cells, there is an advantage in that this gasket is made of an EPDM rubber material having excellent resistance to compressive deformation and resistance to cold, thus providing long-term airtightness under fuel cell operation conditions.

Further, there is an advantage in that, in the fuel cell stack consisting of several hundred unit cells, the amount and content of additives are minimized, thus reducing the prices of raw materials and a fuel cell stack.

Finally, there are advantages in that this gasket for fuel cells does not include metal ions (impurities) which can be eluted therefrom, and thus the components of a fuel cell stack do not become contaminated, thereby improving the durability thereof without reducing the performance thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A gasket for fuel cells, comprising:
1˜5 phr (parts per hundred rubber) of a peroxide crosslinking agent;
0.1˜1 phr of a co-crosslinking agent;
0.1˜1 phr of an antioxidant; and
1˜10 phr of carbon black, in comparison with 100 phr of ethylene-propylene diene monomer (EPDM) rubber, respectively,
wherein the EPDM rubber includes 50˜60 wt. % of ethylene and 4˜10 wt. % of a diene monomer.

2. The gasket for fuel cells of claim 1, wherein the peroxide crosslinking agent includes at least one selected from a group consisting of: dicumyl peroxide, 2,5-dimethyl-2,5-di(t-butylperoxy)hexane, di-(2-t-butylperoxyisopropyl)benzene, di-(2,4-dichlorobenzoyl) peroxide, di(4-methylbenzoyl) peroxide, t-butyl peroxybenzoate, dibenzoyl peroxide, 1,1-di-(t-butylperoxy)-3,3,5-trimethykyclohexane, t-butyl cumyl peroxide, and di-t-butyl peroxide.

3. The gasket for fuel cells of claim 1, wherein the gasket has a Shore A hardness value of 40˜70, based on ASTM D2240.

4. The gasket for fuel cells of claim 1, wherein the gasket has a compression set of 10% or less, based on ASTM D395 (Method B, 25% Deflection, 72 hours, 100° C.).

5. The gasket for fuel cells of claim 1, wherein the gasket abuts a membrane-electrode assembly (MEA), a gas diffusion layer (GDL), a separator, a hydrogen supply unit, an air supply unit or a heat control unit.
